(19) United States
(12) Patent Application Publication
(10) Pub. No.: US 2015/0020019 A1
(43) Pub. Date: Jan. 15, 2015

(54) ELECTRONIC DEVICE AND HUMAN-COMPUTER INTERACTION METHOD FOR SAME

(71) Applicant: HON HAI PRECISION INDUSTRY CO., LTD., New Taipei (TW)

(72) Inventor: TING-AN LIU, New Taipei (TW)

(21) Appl. No.: 14/330,129

(22) Filed: Jul. 14, 2014

(30) Foreign Application Priority Data
Jul. 15, 2013 (TW) 102125150

(51) Int. Cl. G06F 3/0488

(52) U.S. Cl. CPC G06F 3/04883
USPC 715/780

(57) ABSTRACT

An electronic device includes a display member rotatably coupled to a base member. A touchpad is located on a working surface of the base member. The processor determines to enter a handwriting mode according to a first touch gesture when the touchpad detects the first touch gesture, and defines and marks a handwriting frame corresponding to the touchpad on the display upon entrance into the handwriting mode. In the handwriting mode, when the touchpad detects a second touch gesture, the processor displays a handwriting track corresponding to the second touch gesture in the handwriting frame on the display.

### CROSS-REFERENCE TO RELATED APPLICATIONS

This application claims priority to Taiwanese Patent Application No. 102125150 filed on Jul. 15, 2013 in the Taiwan Intellectual Property Office, the contents of which are hereby incorporated by reference.

### FIELD

The disclosure generally relates to electronic devices, and more particularly relates to electronic devices having a touchpad and human-computer interaction methods.

### BACKGROUND

A portable computing device, such as a notebook computer, often uses a touchpad as a “cursor navigator,” as well as a component for selecting functions, such as “select” and “confirm.” However, the conventional touchpad is small and incapable of recognizing more complex touch operations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is an isometric view of an embodiment of an electronic device.

FIG. 2 is a block diagram of the electronic device of FIG. 1.

FIG. 3 illustrates a diagrammatic view of an embodiment of the electronic device in a handwriting mode.

FIG. 4 is a flowchart of an embodiment of a human-computer interaction method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

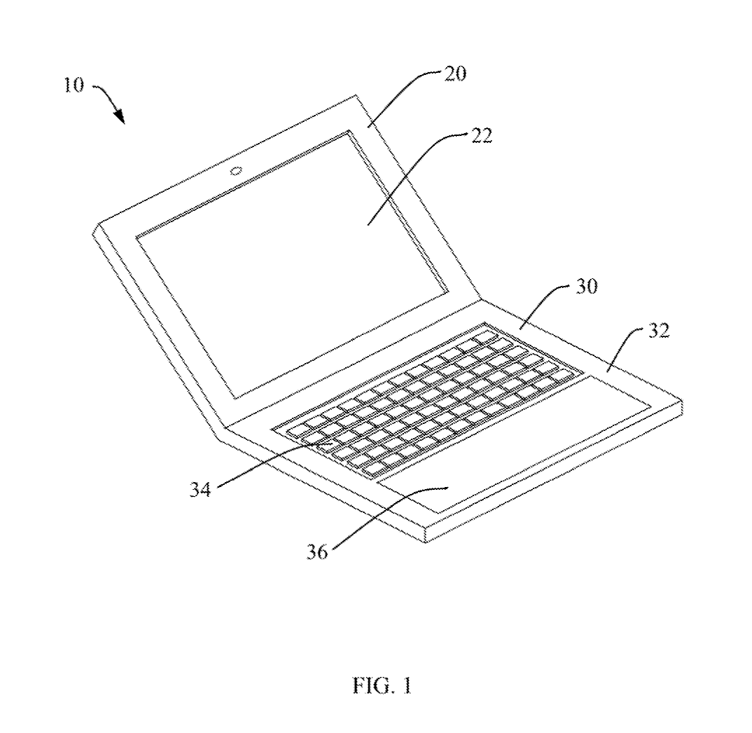

FIG. 1 illustrates an embodiment of an electronic device 10. While the illustrated embodiment is a laptop computer, the electronic device 10 can be, but is not limited to, a notebook computer, a tablet computer, a gaming device, a DVD player, a radio, a television, a personal digital assistant (PDA), a smart phone, or any other type of portable or non-portable electronic device.

The electronic device 10 includes a display member 20 pivotally connected to a base member 30, to enable variable positioning of the display member 10 relative to the base member 30. The display member 20 includes a display 22. A keyboard 34 and a touchpad 36 are located on a working surface 32 of the base member 30. In the illustrated embodiment, the touchpad 36 is located adjacent to the keyboard 34.

In at least one embodiment, a length of the touchpad 36 is greater than 18 centimeters (cm), so that the touchpad 36 is suitable for two-hand operation by a user of the electronic device 10. In another embodiment, the length of the touchpad 36 is substantially the same as a length of the keyboard 34. In other embodiments, the length of the touchpad 36 is substantially the same as a length of the base member 30.

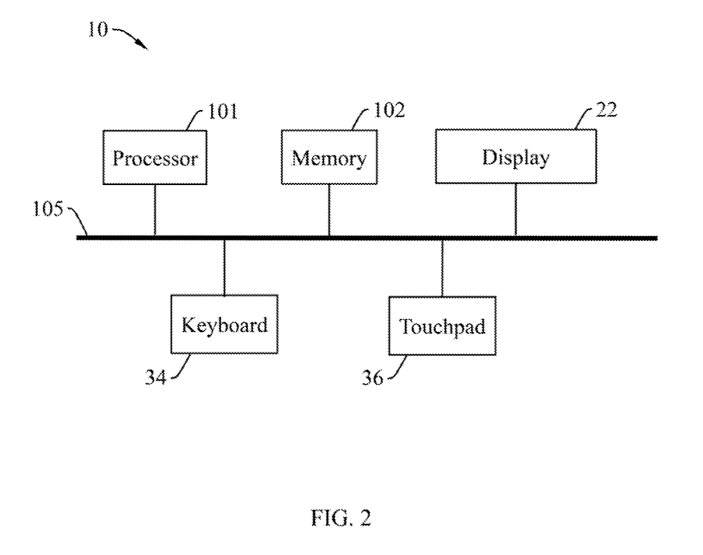

FIG. 2 illustrates a block diagram of an embodiment of the electronic device 10. The electronic device 10 includes at least one processor 101, a suitable amount of memory 102, a display 22, a keyboard 34, and a touchpad 36. The electronic device 10 can include additional elements, components, and modules, and be functionally configured to support various features that are unrelated to the subject matter described herein. In practice, the elements of the electronic device 10 can be coupled together via a bus or any suitable interconnection architecture 105.

The processor 101 can be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein.

The memory 102 can be realized as RAM memory, flash memory, EPROM memory, EEPROM memory, registers, a hard disk, a removable disk, a CD-ROM, or any other form of storage medium known in the art. The memory 102 is coupled to the processor 101, such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The display 22 can be suitably configured to enable the electronic device 10 to render and display various screens, GUIs, GUI control elements, menus, texts, or images, for example. The display 22 can also be utilized for the display of other information during operation of the electronic device 10, as is well understood.

The touchpad 36 can detect and recognize touch gestures input by a user of the electronic device 10. In at least one embodiment, the touchpad 36 includes a touch-sensitive surface made of carbon nanotubes.

When the touchpad 36 detects a first touch gesture, the processor 101 can determine to enter a handwriting mode according to the first touch gesture. In one embodiment, the first touch gesture is a two-finger touch gesture starting from a left edge of the touchpad 36 and moving towards a right edge of the touchpad 36.

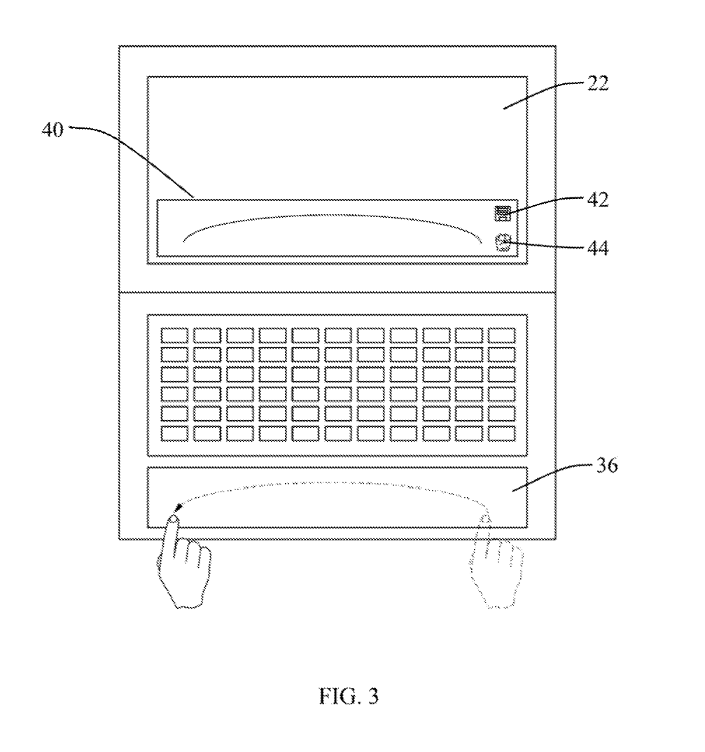

FIG. 3 illustrates a diagrammatic view of an embodiment of the electronic device 10 in the handwriting mode. The processor 101 can define and mark a handwriting frame 40 corresponding to the touchpad 36 on the display 22 upon entrance into the handwriting mode. In the handwriting mode, when the touchpad 36 detects a second touch gesture, the processor 101 can display a handwriting track corresponding to the second touch gesture in the handwriting frame 40 on the display. In one embodiment, the second touch gesture is a single-finger touch gesture made with respect to the touchpad 36.

When the touchpad 36 detects a third touch gesture, the processor 101 can determine to exit the handwriting mode according to the third touch gesture. In one embodiment, the third touch gesture is a two-finger touch gesture starting from the left edge of the touchpad 36 and moving towards the right edge of the touchpad 36. The processor 101 can withdraw the handwriting frame from the display 22 upon exit from the handwriting mode.

When the touchpad 36 detects a fourth touch gesture, the processor 101 can erase one or more portions of the handwriting track in the handwriting frame on the display 22 according to the fourth touch gesture. In at least one embodiment, the fourth touch gesture is a two-finger touch gesture which does not start from any edge of the touchpad 36.

When the touchpad 36 detects a click touch made with respect to an upper-right corner of the touchpad 36, the processor 101 can record the handwriting track displayed in the handwriting frame into a file. When the touchpad 36 detects a click touch made with respect to a lower-right corner of the touchpad 36, the processor 101 can clear the handwriting frame on the display 22 by deleting all of the handwriting tracks displayed in the handwriting frame.

As illustrated in FIG. 3, the processor 101 can display a saving button 42 at the upper-right corner of the handwriting frame 40, and a deleting button 44 at the lower-right corner of the handwriting frame 40. When a user clicks the saving button 42, the processor 101 can record the handwriting track displayed in the handwriting frame into a file. When the user clicks the deleting button 44, the processor 101 can clear the handwriting frame on the display 22 by deleting all of the handwriting tracks displayed in the handwriting frame 40.

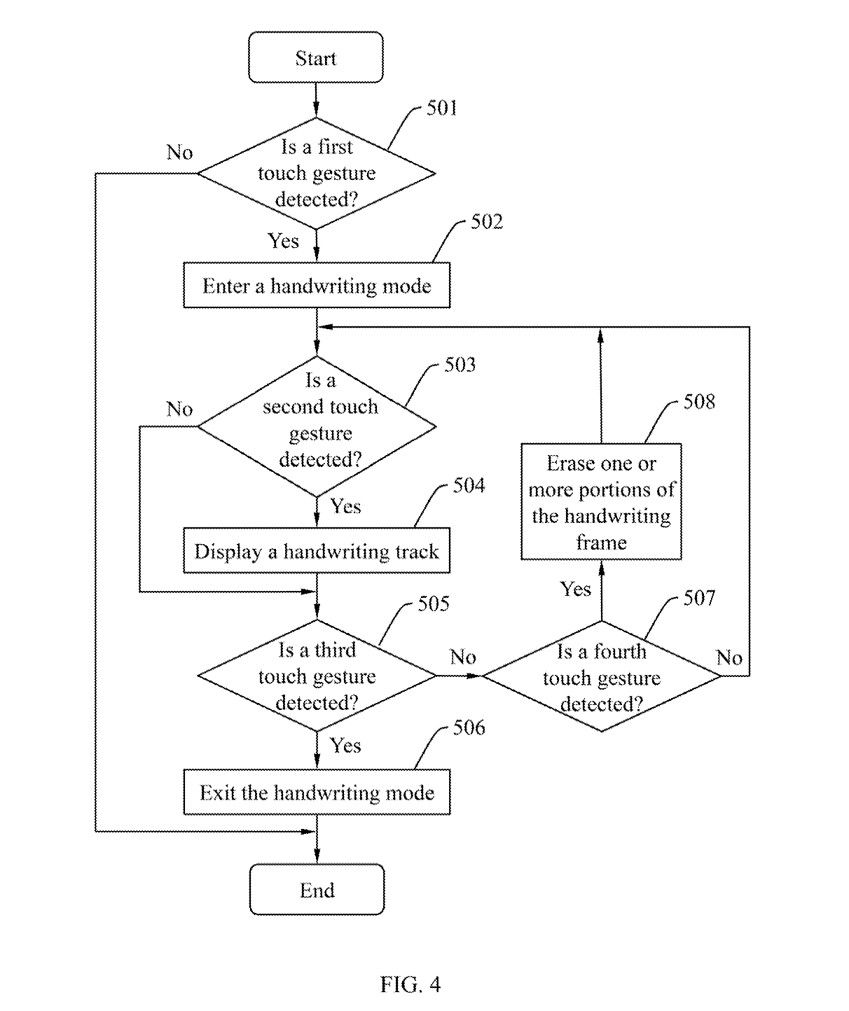

FIG. 4 illustrates a flowchart of one embodiment of a human-computer interaction method. The method includes the following steps.

In block 501, a touchpad determines whether a first touch gesture is detected. If the touchpad detects the first touch gesture, the process proceeds to block 502. Otherwise, the process ends. In one embodiment, the first touch gesture is a two-finger touch gesture starting from a left edge of the touchpad and moving towards a right edge of the touchpad.

In block 502, a processor determines to enter a handwriting mode according to the first touch gesture. The processor defines and marks a handwriting frame corresponding to the touchpad on a display upon entrance into the handwriting mode.

In block 503, the touchpad determines whether a second touch gesture is detected. If the touchpad detects the second touch gesture, the process proceeds to block 504. Otherwise, the process proceeds to block 505. In one embodiment, the second touch gesture is a single-finger touch gesture made with respect to the touchpad.

In block 504, the processor displays a handwriting track corresponding to the second touch gesture in the handwriting frame on the display.

In block 505, the touchpad determines whether a third touch gesture is detected. If the touchpad detects the third touch gesture, the process proceeds to block 506. Otherwise, the process proceeds to block 507. In one embodiment, the third touch gesture is a two-finger touch gesture starting from the left edge of the touchpad and moving towards the right edge of the touchpad.

In block 506, the processor determines to exit the handwriting mode according to the third touch gesture. The processor withdraws the handwriting frame from the display upon exit from the handwriting mode.

In block 507, the touchpad determines whether a fourth touch gesture is detected. If the touchpad detects the fourth touch gesture, the process proceeds to block 508. Otherwise, the process proceeds to block 503. In one embodiment, the fourth touch gesture is a two-finger touch gesture which does not start from any edge of the touchpad.

In block 508, the processor erases one or more portions of the handwriting track in the handwriting frame on the display according to the fourth touch gesture.

In some embodiments, when the touchpad detects a click touch made with respect to an upper-right corner of the touchpad, the processor records the handwriting track into a file. When the touchpad detects a click touch made with respect to a lower-right corner of the touchpad, the processor clears the handwriting frame on the display by removing all of the handwriting tracks displayed in the handwriting frame.

Depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

Although numerous characteristics and advantages have been set forth in the foregoing description of embodiments, together with details of the structures and functions of the embodiments, the disclosure is illustrative only, and changes may be made in detail, including the matters of arrangement of parts within the principles of the disclosure. The disclosed embodiments are illustrative only, and are not intended to limit the scope of the following claims.

What is claimed is:

1. An electronic device comprising:
a base member;
a display member rotatably coupled to the base member, the display member comprising a display;
a touchpad located on a working surface of the base member; and
a processor coupled to the display and the touchpad, the processor configured to determine to enter a handwriting mode according to a first touch gesture when the touchpad detects the first touch gesture, define and mark a handwriting frame corresponding to the touchpad on the display upon entrance into the handwriting mode, and in the handwriting mode, when the touchpad detects a second touch gesture, display a handwriting track corresponding to the second touch gesture in the handwriting frame on the display.

2. The electronic device of claim 1, wherein the processor is further configured to determine to exit the handwriting mode according to a third touch gesture when the touchpad detects the third touch gesture, and withdraw the handwriting frame from the display upon exit from the handwriting mode.

3. The electronic device of claim 2, wherein the first touch gesture is a two-finger touch gesture starting from a first edge of the touchpad and moving towards a second edge of the touchpad.

4. The electronic device of claim 3, wherein the second touch gesture is a single-finger touch gesture made with respect to the touchpad.

5. The electronic device of claim 3, wherein the third touch gesture is a two-finger touch gesture starting from the second edge of the touchpad and moving towards the first edge of the touchpad.

6. The electronic device of claim 1, wherein the processor is further configured to erase one or more portions of the handwriting track in the handwriting frame on the display according to a fourth touch gesture when the touchpad detects the fourth touch gesture.

7. The electronic device of claim 6, wherein the fourth touch gesture is a two-finger touch gesture not starting from any edge of the touchpad.

8. The electronic device of claim 1, wherein the processor is further configured to record the handwriting track into a file when the touchpad detects a click touch made with respect to a first corner of the touchpad.

9. The electronic device of claim 1, wherein the processor is further configured to clear the handwriting frame on the display when the touchpad detects a click touch made with respect to a second corner of the touchpad.

10. The electronic device of claim 1, further comprising a keyboard located on the working surface of the base member, wherein the touchpad is adjacent to the keyboard.

11. A human-computer interaction method implemented in an electronic device, the electronic device comprising a base member, a display member rotatably coupled to the base member, and a touchpad located on a working surface of the base member, the display member comprising a display, the human-computer interaction method comprising, comprising:
determining to enter a handwriting mode according to a first touch gesture when the touchpad detects the first touch gesture;
defining and marking a handwriting frame corresponding to the touchpad on the display upon entrance into the handwriting mode; and
in the handwriting mode, when the touchpad detects a second touch gesture, displaying a handwriting track corresponding to the second touch gesture in the handwriting frame on the display.

12. The human-computer interaction method of claim 11, further comprising:
determining to exit the handwriting mode according to a third touch gesture when the touchpad detects the third touch gesture; and
withdrawing the handwriting frame from the display upon exit from the handwriting mode.

13. The human-computer interaction method of claim 12, wherein the first touch gesture is a two-finger touch gesture starting from a first edge of the touchpad and moving towards a second edge of the touchpad.

14. The human-computer interaction method of claim 13, wherein the second touch gesture is a single-finger touch gesture made with respect to the touchpad.

15. The human-computer interaction method of claim 13, wherein the third touch gesture is a two-finger touch gesture starting from the second edge of the touchpad and moving towards the first edge of the touchpad.

16. The human-computer interaction method of claim 11, further comprising:
erasing one or more portions of the handwriting track in the handwriting frame on the display according to a fourth touch gesture when the touchpad detects the fourth touch gesture.

17. The human-computer interaction method of claim 16, wherein the fourth touch gesture is a two-finger touch gesture not starting from any edge of the touchpad.

18. The human-computer interaction method of claim 11, further comprising:
recording the handwriting track into a file when the touchpad detects a click touch made with respect to a first corner of the touchpad.

19. The human-computer interaction method of claim 11, further comprising:
clearing the handwriting frame on the display when the touchpad detects a click touch made with respect to a second corner of the touchpad.

20. The human-computer interaction method of claim 11, wherein the electronic device further comprises a keyboard located on the working surface of the base member, and the touchpad is adjacent to the keyboard.
